(19) United States
(12) Patent Application Publication
(10) Pub. No.: US 2025/0111172 A1
(43) Pub. Date: Apr. 3, 2025

(54) CONTACT CENTER ASSISTANT

(71) Applicant: State Farm Mutual Automobile Insurance Company, Bloomington, IL (US)

(72) Inventors: Edward W. Breitweiser, Bloomington, IL (US); William Landon Crunk, Henderson, KY (US)

(21) Appl. No.: 18/819,440

(22) Filed: Aug. 29, 2024

Related U.S. Application Data
(60) Provisional application No. 63/586,641, filed on Sep. 29, 2023.

(51) Int. Cl. G06F 40/58; G06N 3/045; G06N 3/0475

(52) U.S. Cl. CPC G06F 40/58; G06N 3/045; G06N 3/0475

(57) ABSTRACT

A contact center assistant may assist representatives associated with a contact center during calls and/or other types of contacts with callers. The contact center assistant may include a generative artificial intelligence (AI) and/or machine learning (ML) model, such as a large language model, that dynamically generates natural language output proactively and/or in response to questions or statements made during contacts. Representatives may accordingly read the natural language output generated by the generative AI model during contacts with callers, and/or otherwise use the natural language output as guidance during contacts with callers.

### PRIORITY

This U.S. Patent Application claims priority to U.S. Provisional Patent Application No. 63/586,641, filed on Sep. 29, 2023, entitled “CONTACT CENTER ASSISTANT,” which is incorporated herein by reference in its entirety.

### TECHNICAL FIELD

The present disclosure relates to a contact center, particularly with respect to a contact center assistant that may suggest statements and/or questions that representatives of the contact center may use to communicate with callers, and/or that may suggest tasks that may be performed during contacts with callers.

### BACKGROUND

A contact center associated with a business or other entity may engage in contacts, such as calls, chat sessions, email exchanges, text messages, and/or other types of communications with customers or other individuals. For example, a caller may call a contact center and be connected to a representative of the call center. The representative may provide information to the caller during the call, and/or take actions to resolve an issue for the caller.

However, in some situations, a representative may be unfamiliar with a particular caller's preferences, and may speak to the caller using a tone and/or a vocabulary that the caller does not prefer. Additionally, in some situations, a representative may address an issue that a caller is specifically calling about during a call, but may be unaware of other issues that could also have been addressed during that call.

The exemplary computer systems and computer-implemented methods described herein may be directed toward mitigating or overcoming one or more of the deficiencies described above. Conventional techniques may have additional drawbacks, inefficiencies, ineffectiveness, and/or encumbrances as well.

### BRIEF SUMMARY

Described herein are systems and methods by which a contact center assistant, associated with a contact center, may assist representatives during calls and/or other types of contacts with callers. The contact center assistant may include a generative artificial intelligence (AI) and/or machine learning (ML) model, such as a large language model, that dynamically generates natural language output proactively and/or in response to questions or statements made during contacts. Representatives may accordingly read the natural language output generated by the generative AI model, or otherwise use the natural language output as guidance, during interactions with callers.

According to a first aspect, a computer-implemented method includes providing a contact center assistant. The computer-implemented method may be implemented via one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another. For example, in one instance, the computer-implemented method may include (1) providing, by a computing system including one or more processors, a contact center assistant including a representative coach. The representative coach may be trained, based upon a training dataset, to assist a representative associated with a contact center. The computer-implemented method may also include (2) monitoring, by the computing system, and via the contact center assistant, a contact between a caller and the representative associated with a contact center. The computer-implemented method may additionally include (3) dynamically generating, by the computing system, and via the representative coach based at least in part upon monitoring the contact, natural language output associated with the contact. The computer-implemented method may also include (4) presenting, by the computing system, the natural language output to the representative via a user interface of the contact center assistant. The method may include additional, less, or alternate functionality and actions, including those discussed elsewhere herein.

According to a second aspect, a computing system may provide a contact center assistant. The computing system may include one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another. For example, in one instance, the computing system may include one or more processors, and memory storing computer-executable instructions associated with a contact center assistant. The computer-executable instructions, when executed by the one or more processors, may cause the one or more processors to (1) monitor, via the contact center assistant, a contact between a caller and a representative associated with a contact center. The computer-executable instructions may also cause the one or more processors to (2) dynamically generate, by a representative coach of the contact center assistant, natural language output associated with the contact. The representative coach may include a generative pre-trained transformer (GPT) model that is trained on a training dataset. The computer-executable instructions may additionally cause the one or more processors to (3) present the natural language output to the representative via a user interface of the contact center assistant. The computing system may include additional, less, or alternate functionality, including that discussed elsewhere herein.

According to a third aspect, one or more non-transitory computer-readable media store computer-executable instructions associated with a contact center assistant that may be executed by one or more processors of a computing system. The computing system may include one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another. For example, in one instance, the computer-executable instructions may cause the one or more processors to: (1) monitor, via the contact center assistant, a contact between a caller and a representative associated with a contact center. The computer-executable instructions may also cause the one or more processors to (2) dynamically generate, by a representative coach of the contact center assistant, natural language output associated with the contact. The representative coach may include a generative pre-trained transformer (GPT) model that is trained on a training dataset. The computer-executable instructions may additionally cause the one or more processors to (3) present the natural language output to the representative via a user interface of the contact center assistant. The computer-executable instructions may cause additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 shows an exemplary computing environment in which a contact center assistant operates to assist representatives of a contact center, and/or other systems associated with the contact center.

FIG. 2 shows a flowchart illustrating an exemplary computer-implemented method for dynamically generating output during contacts via the contact center assistant.

FIG. 3 shows a flowchart illustrating an exemplary computer-implemented method for managing a contact via the contact center assistant.

FIG. 4 shows an exemplary system architecture for a computing system that may execute one or more elements associated with the contact center assistant, a model training system, and/or other elements described herein.

The detailed description is set forth with reference to the accompanying figures. In the figures, the left-most digit(s) of a reference number identifies the figure in which the reference number first appears. The use of the same reference numbers in different figures indicates similar or identical items or features.

### DETAILED DESCRIPTION

Computer systems and computer-implemented methods are described herein by which a computer-implemented contact center assistant, associated with a contact center, may, inter alia, assist representatives during calls and/or other types of contacts with callers. The contact center assistant may include a generative artificial intelligence (AI) and/or machine learning (ML) model, such as a large language model, that dynamically generates natural language output proactively and/or in response to questions or statements made during contacts. Representatives may accordingly read the natural language output generated by the generative AI model, or use the natural language output as guidance, during interactions with callers.

For example, by using a generative AI/ML model, the contact center assistant may take in messages from callers, representatives, and/or other individuals or entities. The generative AI/ML model may access information, such as insurance policy information and/or other information, from internal systems and/or other data sources, and use that information to generate answers to questions via such messages. The generative AI/ML model may also analyze questions coming in, as well as caller profiles, to generate answers that callers may be more likely to understand and remember. Similarly, the generative AI/ML model may work with callers, representatives, and/or other entities or systems to help formulate questions that may be asked to lead to a satisfying answer. The generative AI/ML model may additionally perform some form-based tasks, paperwork-based tasks, and/or other tasks, and/or walk callers, representatives, and/or other users through processes.

The generative AI/ML model may also, or alternately, determine information that is potentially useful, and/or that is likely for callers to inquire about. The AI/ML model may, for example, determine when a large influx of calls is likely to occur due to a natural disaster or other wide-spread event. The AI/ML model may generate corresponding information, forms, answers to likely questions from callers, or follow-up questions to ask callers. In some examples, the AI/ML model may directly interface with callers, for instance to reduce wait times and/or to determine when and to whom to transfer callers for additional expertise or information. The AI/ML model may also, or alternately, determine products or services that may be useful or relevant to a caller or a potential caller.

The generative AI/ML model may also, or alternately, receive audio files, such as of a call with a representative, and transcribe or summarize the information exchanged during the call. The AI/ML model may provide the summary to other representatives who speak with the customer, and/or or may analyze the summary for potential questions or expected answers, such as via a bot token attached to a call transfer. Additionally, the generative AI/ML model may perform translation or analysis of other languages as appropriate. The AI/ML model may further generate information or notices for a user in another language, and/or based upon particular language preferences based upon interactions with the user and/or a user profile.

### Exemplary Computing Environment

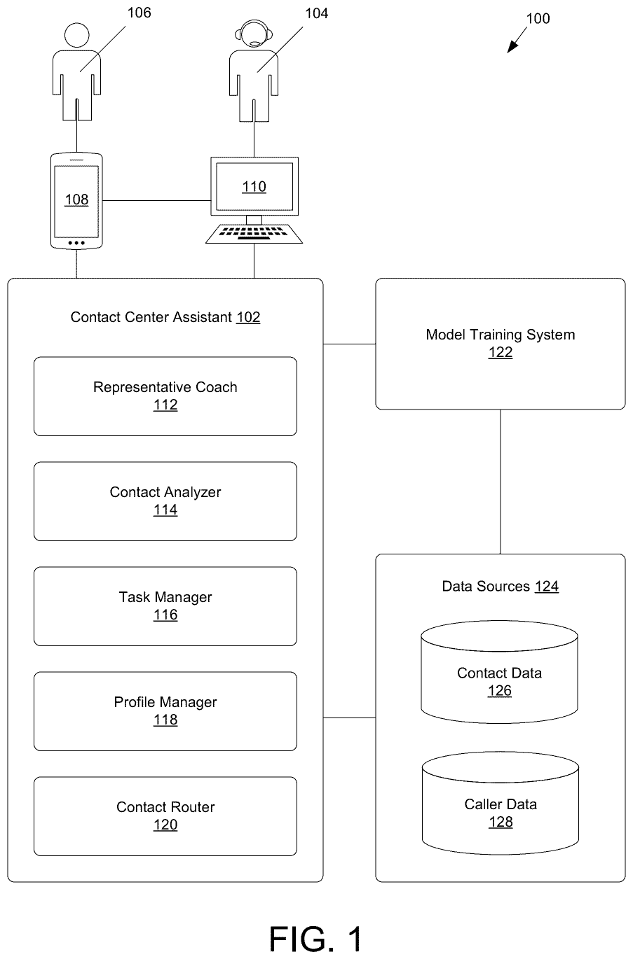

FIG. 1 shows an exemplary computing environment 100 in which a contact center assistant 102 operates to assist representatives 104 of a contact center, and/or other systems associated with the contact center. The contact center assistant 102 may be a computer-implemented platform or application used by, and/or within, the contact center. The contact center may be staffed with representatives 104 who engage in contacts with callers 106. The contacts between the representatives 104 and callers 106 may include voice calls, video calls, emails, chat sessions, text messages, and/or other types of communications. Accordingly, although the term “caller” is used herein to refer to an individual or entity that engages in a contact with the contact center, a “caller” may use a text-based contact, a video-based contact, or other type of contact instead of, or in addition to, an audio call to communicate with one or more representatives 104 at the contact center.

The contact center may be associated with an entity, such as a business or other organization. Callers 106 who engage in contacts with the contact center may include current customers of the entity, potential customers of the entity, current and/or prospective members of the entity, employees and/or agents of the entity, and/or any other individuals or entities who may contact representatives 104 at the contact center and/or who may be contacted by representatives 104 at the contact center. As an example, if the contact center is associated with an insurance company, callers 106 may include policyholders associated with insurance policies provided by the insurance company, prospective policyholders who do not yet have insurance policies with the insurance company, employees of the insurance company, insurance agents associated with the insurance company, and/or other individuals or entities that may contact, or may be contacted by, the contact center.

Representatives 104 and callers 106 may use communications devices and/or computing devices to engage in contacts. For example, a caller 106 may use a user device 108, such as a smartphone or other telephone, a computer, or other type of user device, to engage in an audio call or other type of contact with the contact center. A representative 104 of the contact center may similarly use at least one representative device 110, such as a telephone and/or computer, to communicate with the caller 106 during the contact. The representative 104 may also use a representative device 110, such as a computer, to access and/or use the contact center assistant 102 as described herein. In some examples, the representative 104 may also use the representative device 110 to access and/or use one or more other applications before, during, and/or after contacts with callers 106, for instance by accessing a customer relationship management (CRM) platform and/or other applications via the representative device 110.

In some examples, the contact center assistant 102 may execute separately from a CRM platform and/or other applications that may be used via the representative device 110. The contact center assistant 102 may, in some examples, interact with such other applications via one or more Application Programming Interfaces (APIs) or other interfaces or connections, for instance to access data stored by and/or managed by a CRM platform. In other examples, the contact center assistant 102 may be an element of a CRM platform or other application, or be a plug-in or other element that enhances or augments functions of a CRM platform or other application.

The contact center assistant 102 may have a representative coach 112 that is configured to assist representatives 104 during contacts with callers 106. The representative coach 112 may dynamically generate output that is presented to representatives 104 via a user interface (UI) of the contact center assistant 102, for instance via the representative device 110.

The output generated by the contact center assistant 102 in association with a contact, presented via a UI, may assist a representative 104 during the contact in one or more ways. For instance, the output generated by the contact center assistant 102 may direct the representative 104 to ask a particular question to a caller 106 during a contact, direct the representative 104 to provide particular information to the caller 106 during the contact, suggest one or more recommended responses to a question posed by the caller 106, and/or direct the representative 104 perform other actions during the contact with the caller 106.

As an example, the output of the representative coach 112 may include dynamically-generated natural language text of a question that a representative 104 should ask a caller 106 during a contact. The question may ask the caller 106 to provide particular information identified by one or more elements of the contact center assistant 102, and/or may be a follow-up question that is related to one or more previous questions or statements made during the contact or previous contacts. As another example, the output of the representative coach 112 may include dynamically-generated natural language text of a recommended answer to a question that a caller 106 posed during a contact. As yet another example, the output of the representative coach 112 may include dynamically-generated natural language text of a statement that a representative 104 should read to a caller 106 to convey information to the caller 106, such as information about a recommended product or service, information about a task or secondary issue that could be addressed during a contact about a primary issue, and/or other information as described herein. Other examples of output generated by the representative coach 112 are discussed further below.

Overall, representatives 104 may interact with callers 106 at least in part based upon output that is dynamically generated by the representative coach 112 and that is presented via a UI of the contact center assistant 102. The representative coach 112 may be based upon a generative artificial intelligence (AI) system, and/or other types of AI and/or machine learning (ML) techniques. The representative coach 112 may, based upon such AI and/or ML techniques, be configured to dynamically generate natural language text and/or other types of output data that may be relevant to contacts with callers 106 and/or that may assist representatives 104 during such contacts with callers 106.

For example, the representative coach 112 may be, or include, a generative pre-trained transformer (GPT) model and/or a large language model. Such a GPT model and/or a large language model may be similar to models such as OpenAI GPT-4, Meta LLaMa, or Google PaML 2. For instance, the representative coach 112 may be based upon a model similar to ChatGPT®, and/or employ the techniques utilized for ChatGPT. The representative coach 112 may employ supervised or unsupervised ML techniques, which may be followed by, and/or used in conjunction with, reinforced or reinforcement learning techniques.

The output generated by the representative coach 112 may be dynamically generated as natural language content, such as natural language questions and/or natural language statements. Accordingly, the representative coach 112 may output dynamically-generated natural language content instead of, or in addition to prewritten or predetermined content. The representative coach 112 may accordingly generate natural language output that expresses information, and/or that requests information, conversationally within a context of the contact. The representative coach 112 may accordingly be considered to be a chatbot, voice bot, or other generative AI system that may receive and/or analyze natural language input, such as questions or statements made by a caller 106 and/or a representative 104 during a contact, and that may dynamically generate corresponding output based upon such input and/or other information available to the representative coach 112.

In some examples, the representative coach 112 may dynamically generate output based upon information associated with a contact, based upon the caller 106 associated with the contact, and/or based upon other information. Such information may be provided and/or determined by elements such as a contact analyzer 114, a task manager 116, a profile manager 118, a contact router 120, and/or other elements. Elements such as the contact analyzer 114, the task manager 116, the profile manager 118, and/or the contact router 120 may be components of the representative coach 112, may be other components of the contact center assistant 102, and/or may be components of other systems.

The contact analyzer 114 associated with the representative coach 112 may monitor and/or analyze an on-going contact with a caller 106. The contact analyzer 114 may, for example, include speech-to-text conversions systems, audio analysis systems, sentiment analysis systems, and/or other systems that may monitor and/or analyze the content of an on-going contact. For instance, the contact analyzer 114 may provide audio data and/or a corresponding transcript of the contact to the representative coach 112. The contact analyzer 114 may also be configured to analyze sentiments expressed by representatives 104 and/or callers 106 during contacts, for instance by analyzing text data and/or audio data to determine whether callers 106 were happy, angry, or experiencing other emotions during the contacts.

In some examples, the contact analyzer 114 may transcribe and/or summarize individual contacts. Accordingly, the contact center assistant 102 may provide transcripts and/or summaries of previous contacts involving a particular caller 106 to a representative 104 who next handles a contact associated with that particular caller 106, and/or provide such a transcript and/or summary of an on-going contact to a subsequent representative 104 when the current contact is transferred from a previous representative 104 to the subsequent representative 104.

The representative coach 112 may dynamically generate output during a contact based upon information provided by, and/or determinations made by, the contact analyzer 114. For instance, if a caller 106 asks a question during a contact, the contact analyzer 114 may provide a text and/or audio representation of the question to the representative coach 112, such that the representative coach 112 may dynamically generate a suggested response to the question. The representative coach 112 may present the suggested response to the representative 104 via a UI of the contact center assistant 102, such that the representative 104 may read the suggested response to the caller 106 or otherwise convey the content of the suggested response to the caller 106. The representative coach 112 may also dynamically generate a suggested response to a question, or other output, based upon a sentiment analysis performed by the contact analyzer 114. For instance, if the contact analyzer 114 determines that the caller 106 is angry or frustrated during a contact, the representative coach 112 may generate natural language output that is expressed in a calming or reassuring tone, such that the representative 104 may read the natural language output to the caller 106 to help calm or reassure the caller 106.

The task manager 116 associated with the representative coach 112 may, during an on-going contact with a caller 106, determine one or more tasks associated with the caller 106 that could be performed during the contact. For instance, as explained further below, the caller 106 may have initiated a contact with the contact center in order to address a first issue. However, the task manager 116 may identify one or more additional issues associated with the caller that could also be addressed during the current contact. Identification of such additional issues may cause the representative coach 112 to generate output that suggests that the representative 104 inquire about and/or attempt to resolve the one or more additional issues during the contact.

Accordingly, although the caller 106 contacted the contact center about the first issue, the representative 104 may be able to address one or more other issues during the same call, and thereby prevent potential subsequent contacts to and/or from the caller 106 regarding the additional issues. For instance, the task manager 116 may identify an additional issue, different from the first issue, of which the caller 106 and/or the representative 104 may not have been aware. The additional issue, if left unaddressed, may have led to a second contact with the caller 106 about the additional issue at a later point in time, such as days, weeks, or months later. However, based upon identification of the additional issue by the task manager 116 during the current contact about the first issue, the representative coach 112 may generate output that prompts the representative 104 to address the additional issue during the current contact as well as addressing the first issue. The additional issue may accordingly be addressed proactively during the current contact, such that a subsequent contact with the caller about the additional issue may be avoided and the additional issue may be addressed more quickly and/or efficiently.

As described further below, the task manager 116 may also identify and/or perform tasks automatically in association with contacts. Accordingly, such tasks may be performed by the task manager 116 instead of, or in addition to, such tasks being performed manually by representatives 104.

The profile manager 118 associated with the representative coach 112 may, in association with a contact with a caller 106, generate and/or determine a profile associated with the caller 106. The representative coach 112 may generate output based upon information indicated in a caller's profile. For example, profiles associated with callers 106, managed by the profile manager 118, may indicate language preferences of the caller 106. Such language preferences may indicate which languages and/or dialects the caller 106 speaks. Such language preference may also indicate tone preferences indicating whether the caller prefers serious statements, humorous statements, short statements, long statements, and/or other types of tone variations. Accordingly, based upon language preferences indicated in a caller's profile, the representative coach 112 may dynamically generate natural language output during a contact with the caller 106 that poses questions and/or expresses information in a language and/or tone that corresponds with the caller's language preferences.

The contact router 120 associated with the representative coach 112 may identify situations in which a caller 106 should be transferred between representatives 104. Accordingly, if a caller 106 is engaged in a contact with a first representative 104, and the contact router 120 determines that the caller 106 should be transferred to a second representative 104, the representative coach 112 may dynamically generate natural language output that the first representative 104 may use to suggest and/or explain the transfer of the caller 106 to the second representative 104. The contact router 120 may also, or alternately route incoming contacts to particular selected representatives 104, suggest that outgoing contacts be made by representatives 104 to particular callers 106, and/or perform other routing operations. In some examples, the contact router 120 may generate routing and/or transferring determinations or recommendations based upon language preferences determined by the profile manager 118, tasks identified by the task manager 116, and/or other determinations made by elements of the contact center assistant 102, as described further below.

One or more models associated with the representative coach 112, and/or other elements of the contact center assistant 102, may be trained by a model training system 122 using supervised learning, reinforcement learning, and/or other machine learning techniques. The model training system 122 may be a computer-executable system that is configured to train one or more models associated with the representative coach 112 and/or other elements of the contact center assistant 102. For example, the model training system 122 may be configured to train one or more models associated with the representative coach 112 and/or elements such as the contact analyzer 114, the task manager 116, the profile manager 118, the contact router 120 of the contact center assistant 102, and/or other elements.

The model training system 122 may use a training dataset to train one or more models associated with a representative coach 112 and/or other elements of the contact center assistant 102. The training dataset used by the model training system 122 to train the representative coach 112 and/or other elements of the contact center assistant 102 may be based upon one or more types of information that may be provided and/or maintained by one or more data sources 124. The data sources 124 may store contact data 126, caller data 128, and/or other types of data. Accordingly, the representative coach 112 may be trained to generate output that expresses information indicated by, and/or derived from, one or more data sources 124 during contacts with callers 106, as described herein.

The contact data 126 may include information associated with a historical set of contacts between representatives 104 and callers 106. For example, the contact data 126 may include transcripts and/or recordings of previous contacts. The contact data 126 may also indicate one or more types of feedback associated with the previous contacts. Such feedback data may include Quality Assurance (QA) scores, and/or other QA data, generated based upon manual review of transcripts and/or recordings of previous contacts. The QA data associated with a particular contact may indicate a manual reviewer's subjective determination of whether the contact successfully resolved a caller's problem, whether a representative 104 used language with an appropriate tone while dealing with the caller 106, and/or other types of feedback regarding the contact. For instance, QA data may indicate subjective determinations of why particular contacts did, or did not, successfully address issues for callers 106. In some examples, the feedback may also, or alternately, include automatically-generated sentiment analysis metrics, survey results provided by callers 106 following completion of the contacts, and/or other types of feedback.

In some examples, contact data 126 associated with individual contacts may be generated by, updated by, and/or managed by the contact analyzer 114. For example, as discussed above, the contact analyzer 114 may monitor and/or analyze contacts with callers 106, for instance to generate audio recordings of contacts, generate transcripts of the contacts, perform sentiment analysis in association with the contacts, and/or otherwise monitor and/or analyze content of the contacts. Corresponding information captured and/or determined by the contact analyzer 114 may be stored in the contact data 126 in association with corresponding contacts.

The caller data 128 may indicate information associated with corresponding callers 106. If callers 106 are existing customers of a company, the caller data 128 may indicate products and/or services that the callers 106 have ordered in the past, are currently subscribed to, and/or that are otherwise associated with the callers 106. As an example, if callers 106 are policyholders of insurance policies provided by an insurance company, the caller data 128 may indicate information about the insurance policies, such as types of the insurance policies, rates associated with the insurance policies, coverage limits associated with the insurance policies, terms of the insurance policies, and/or other information about the insurance policies. The caller data 128 may also indicate billing information associated with callers 106, contact information associated with callers 106, demographic information associated with callers 106, and/or other types of information associated with callers 106.

In some examples, the caller data 128 may include information stored in a CRM platform and/or other systems, and the model training system 122 and/or contact center assistant 102 may access the caller data 128 from the CRM platform and/or other systems via one or more APIs or other interfaces. The caller data 128 may also, or alternately, include caller profiles generated by, updated by, and/or otherwise managed by the profile manager 118. For instance, the caller data 128 may include caller profiles managed by the profile manager 118 that indicate language preferences of corresponding callers 106, such as language preferences, dialect preferences, tone preferences, and/or other types of language preferences.

In some examples, the model training system 122 may be at least partially separate from the contact center assistant 102, and may execute to train and/or re-train instances of the representative coach 112 and/or other elements of the contact center assistant 102. Trained instances of one or more models associated with the representative coach 112 and/or other elements described herein may accordingly be deployed in the contact center assistant 102. For example, the model training system 122 may train the representative coach 112 to generate conversational natural language output, such as statements and/or questions, proactively during a contact with a caller 106 and/or in response to previous statements and/or questions made by the caller 106 or a representative 104 during the contact. The representative coach 112 may generate such output dynamically based upon information that was in a training dataset at the time the representative coach 112 was trained, and/or based upon information in the data sources 124 and/or other information that may be accessed by the representative coach 112.

As discussed above, the representative coach 112 may be based upon a generative AI system and/or other machine learning techniques, such as a GPT model and/or a large language model. The model training system 122 may accordingly train one or more models associated with the representative coach 112 via supervised learning, reinforcement learning, and/or other machine learning techniques. For example, the model training system 122 may train the representative coach 112 based upon supervised learning using labeled data within the training dataset, such that the training causes the representative coach 112 to predict which labeled data is responsive to example input.

As an example, as discussed above, the contact data 126 may include transcripts and other information associated with a historical set of contacts. The contact data 126 may also include feedback data associated with the historical set of contacts, such as QA metrics, sentiment analysis scores, caller feedback scores, and/or other feedback. Such feedback data may be used as labeling data to indicate which contacts, within the historical set of contacts, are considered to be desirable instances of interactions with callers 106 and which contacts are considered to be undesirable instances of interactions with callers 106. For example, if QA metrics assign review scores of 1-100 to historical contacts, and contacts associated with review scores of 80 or higher, or any other threshold review score, may be considered to be desirable instances of interactions with callers 106. Accordingly, the model training system 122 may train the representative coach 112 to dynamically generate natural language output based at least in part upon text and/or audio associated with a set of contacts associated with at least a threshold review score.

Accordingly, the representative coach 112 may be trained to generate example output in response to example input. The example output generated by the representative coach 112 during the training process may also be manually reviewed via the model training system 122 to determine whether the output generated by the representative coach 112 adequately responds to the example input. For instance, manual feedback may indicate whether or not statements generated by the representative coach 112 covered accurate and relevant information, sufficiently responded to example user questions, and/or were readable and understandable by humans. Feedback provided during such manual review may be used via Reinforcement Learning from Human Feedback (RLHF) techniques to further train or retrain the representative coach 112.

After the representative coach 112 has been trained or re-trained via the model training system 122, a trained instance of the representative coach 112 may be deployed. For example, a trained instance of the representative coach 112 may be deployed in the contact center assistant 102, such that the representative coach 112 may generate output that may be used by representatives 104 during corresponding contacts with callers 106. Statements, questions, and/or other output dynamically generated by the representative coach 112 during such contacts may be based upon information that was in the training dataset when the representative coach 112 was trained, and/or that was not in the training dataset but may be accessed by the contact center assistant 102 during the contacts. For example, although the training dataset may include historical caller data 128 about a set of callers, the representative coach 112 may generate output during a contact with another caller, not in the set of callers, based upon caller data 128 associated with that caller.

As discussed above, the contact center assistant 102 may include other elements that are part of the representative coach 112 and/or that may interact with the representative coach 112, such as the contact analyzer 114, the task manager 116, the profile manager 118, the contact router 120, and/or other elements. These elements may, in some examples, be based at least in part upon rules-based models, machine learning models, and/or other types of models. For example, such elements may be include one or more machine learning models based upon convolutional neural networks, recurrent neural networks, other types of neural networks, nearest-neighbor algorithms, regression analysis, deep learning algorithms, Gradient Boosted Machines (GBMs), Random Forest algorithms, and/or other types of artificial intelligence or machine learning frameworks. The model training system 122 may train such machine learning elements based upon training datasets, such as historical data, using supervised machine learning and/or unsupervised machine learning.

As an example, the task manager 116 may be a machine learning model that is trained based upon historical data indicating attributes of situations in which labeled data indicates certain tasks were performed or should have been performed. Accordingly, the model training system 122 may train the task manager 116 to identify which tasks should be performed in certain situations, such that the task manager 116 may identify such situations and corresponding tasks to be performed during contacts with callers 106 as described herein.

Overall, the representative coach 112 and/or other elements of the contact center assistant 102 may be configured assist representatives 104 of the contact center during contacts with callers 106. As an example, based upon monitoring of an on-going contact with a caller 106 by the contact analyzer 114, the representative coach 112 may determine when the caller 106 asks a question, identify corresponding information in caller data 128 and/or other data sources 124, and dynamically generate natural language output that a representative 104 may convey to the caller 106. Representatives 104 may accordingly respond to questions from callers 106 substantially immediately based upon output generated automatically and dynamically by the representative coach 112, and may also avoid taking time and effort to manually look up information when attempting to respond to questions from callers 106.

For instance, if during a contact a caller 106 asks how much the caller's monthly billing amount is, the representative coach 112 may use caller data 128 to look up the caller's monthly billing amount. The representative coach 112 may also dynamically generate corresponding natural language output such as “I see from your account data that your monthly billing amount is $89.00,” and present the natural language output via a UI of the contact center assistant 102. The representative 104 may read the output generated by the representative coach 112 to the caller 106. Accordingly, the representative 104 may respond to the caller's question quickly based upon the output generated by the representative coach 112. The representative 104 may also avoid taking time and effort, and avoid using corresponding computing resources, to manually look up the caller's monthly billing amount.

The representative coach 112 may also provide information during a contact questions that a representative 104 may not otherwise have been able to look up or provide during the contact. As an example, a caller 106 may have a life insurance policy and want to know how the caller 106 may use money from the life insurance policy to pay for college for the caller's child. The representative may not personally be aware of all the ways the caller 106 could access money from the life insurance policy for that purpose, or know which particular way may be best for the caller's situation. However, the representative coach 112 and/or other elements of the contact center assistant 102 may determine one or more options for accessing money from a life insurance policy that may be available to the caller 106, and/or determine which of the options is recommended for the caller 106. The representative coach 112 may also dynamically generate output that the representative 104 may use to convey such information to the caller 106.

The representative coach 112 and/or other elements of the contact center assistant 102 may identify available options and/or recommend a particular option based upon caller data 128 associated with the caller 106 and/or the caller's life insurance policy, historical data associated with other life insurance policyholders, and/or other information. For example, the representative coach 112 and/or other elements of the contact center assistant 102 may access caller data 128 about the caller 106 to identify information about the caller's life insurance policy.

The representative coach 112 and/or other elements of the contact center assistant 102 may also access other information indicating different ways of accessing money from life insurance policies to pay for college, historical financial outcomes of other individuals who have previously used those different ways to access money from life insurance policies to pay for college, and/or other information. Accordingly, the representative coach 112 and/or other elements of the contact center assistant 102 may determine which ways are available to the caller 106, and/or may use historical data associated with other policyholders who were in similar situations to predict which of the ways is most likely to lead to an optimal financial outcome for the caller 106.

The representative coach 112 may generate corresponding output that the representative 104 may use to express the options and/or a recommendation to the caller 106. The output may, for instance, identify available options, indicate a recommended option, indicate tax implications of one or more options, indicate how quickly money would be available based upon one or more options, indicate how accessing money to pay for college would impact the life insurance policy, and/or indicate other information. In this example, the representative 104 may not personally know all of the different options for accessing money from life insurance policies to pay for college, may not personally know how the different options have financially impacted other people in the past, may not personally have the experience to determine which specific option to recommend to the caller 106, and/or may not personally have the time, resources, or experience to look up or determine the information conveyed by the output generated by the representative coach 112. However, because the representative coach 112 may dynamically generate output that expresses such information during the contact with the caller 106, the representative 104 may convey the information to the caller 106 during the contact.

As discussed above, the representative coach 112 may dynamically generate conversational natural language output that conveys information. If language preferences associated with a caller 106 are indicated in corresponding caller data 128, the representative coach 112 may dynamically generate output that is responsive to the caller's questions in a particular language, dialect, and/or tone preferred by the caller 106. Such language preferences may be determined by the profile manager 118 based upon previous contacts and/or earlier interactions during the current contact.

For instance, if the caller 106 has demonstrated a preference for humor, the representative coach 112 may generate output that expresses information responsive to the caller's question in a lighthearted or humorous way. If the caller 106 has instead demonstrated a preference for short and straightforward interactions, the representative coach 112 may generate different output that expresses the same underlying information that is responsive to the caller's question using more straightforward words and/or phrases. Accordingly, by dynamically generating output that is responsive to a caller's question and that is also expressed using words and/or phrases that correspond to a caller's language preferences, the caller may be more likely to be satisfied with the contact and/or may be more likely to understand the information conveyed during the contact.

Similarly, the representative coach 112 may use a caller's language preferences, and/or previous questions or statements made during the contact and/or previous contacts to, to dynamically generate questions that the representative 104 may ask to the caller 106. The representative coach 112 may dynamically generate such questions by formulating the questions based upon the caller's language preferences such that the questions are likely to be understood by the caller 106 and/or are likely to cause the caller 106 to provide responsive information.

In some examples, the representative coach 112 may generate output expressed in a particular language that the caller 106 prefers. The representative coach 112 may also, in some examples, perform translation services substantially in real-time during a contact. For example, if a caller 106 speaks Spanish and a representative speaks English, the representative coach 112 may generate an English translation of Spanish-language input from the caller 106 and provide the English translation to the representative 104. Similarly, the representative coach 112 may generate Spanish translation of English-language input from the representative 104, and/or generate other types of output described herein as Spanish-language output, and provide such Spanish-language content to the caller 106.

The representative coach 112 may also, or alternately, generate natural language statements or other content that may steer a conversation with a caller 106 to a topic suggested by one or more elements of the contact center assistant 102, that presents suggestions or recommendations to the caller 106, and/or that conveys any other type of information. For instance, the representative coach 112 may generate questions and/or statements during a contact based at least in part upon a task or other issue identified by the task manager 116. Accordingly, the task or issue may be addressed during the contact. The task or other issue identified by the task manager 116 may be related to the original reason for the contact, or may be unrelated to the original reason for the contact. In some situations, addressing a task identified by the task manager 116 during the contact may prevent one or more future contacts and/or may prevent problems that could otherwise have arisen if the task had been left unaddressed. Proactively addressing such identified tasks during contacts and/or proactively avoiding potential future problems may lead to more efficient operations of the contact center and/or other systems, for instance by reducing overall usage of computing resources that would otherwise have been associated with the avoided future contacts and/or avoided future problems.

As an example, a caller 106 may call the contact center to ask that a representative 104 adjust an insurance policy associated with the caller 106. However, during the call with the caller 106, the task manager 116 may access caller data 128 associated with the caller 106, and determine that different billing address information associated with the caller 106 is stored within different databases. In this example, although the original purpose of the call was about adjusting the caller's insurance policy, the task manager 116 may determine that a representative 104 should also ask for the caller's correct billing address during the same call. The representative coach 112 may dynamically generate corresponding output such as “Hey, while I have you on the phone, it looks like we may not have your correct billing address. Could you give me that?” In this example, the representative 104 may not have been looking at billing databases while assisting the caller with changes to the insurance policy, and might not otherwise have been aware of the mismatched billing address information or asked the caller 106 for billing address information.

In this example, by inquiring about and/or obtaining the customer's correct billing address during the same call that was initially about adjusting an insurance policy, both issues may be addressed during the same call. Moreover, future issues that may have caused by mismatched billing address information, and/or additional communications that may otherwise insurance been needed to determine the caller's correct billing address, may be avoided. For example, if the caller 106 called in January to adjust the insurance policy, but the next billing period for the insurance policy was not until April, billing issues caused by the mismatched billing address information in the databases may not have otherwise occurred until April. If such billing issues were to have occurred in April, computing resources and/or human resources may have been devoted to resolving the billing issues, for example by tasking automated computer-implemented systems to send email messages to the caller regarding the billing issues and/or tasking representatives 104 to reach out to the caller 106 to attempt to obtain the caller's correct billing address. However, because the task manager 116 may identify the mismatched billing address information and the representative coach 112 may prompt a representative to ask about the caller's billing address while on the phone with the caller in January about an unrelated issue, other computer-implemented operations and/or contacts that may otherwise have occurred in April may be avoided. Reduction of likelihoods of such later issues by proactively addressing issues identified by the task manager 116 may reduce overall usage of processing cycles, memory, bandwidth, and/or other computing resources.

As another example, a caller 106 may call to inquire about the status of a life insurance application. Processing of the life insurance application may have been in progress, but may have temporarily stalled because one or more types of additional information are needed from the caller 106. Future calls or other contacts, or future electronic communications or data processing may have been planned to attempt to obtain that information from the caller 106 or other sources, but may not have occurred yet. However, during the current call the task manager 116 may identify which types of additional information are needed from the caller 106, and the representative coach 112 may generate output prompting the representative 104 to ask for those particular types of additional information during the current call. Accordingly, the information may be obtained from the caller 106 during the current call. Future calls and/or operations may be cancelled and/or avoided, and corresponding usage of computing resources associated with such future calls and/or operations may also be avoided.

In some examples, the task manager 116 and/or other elements of the contact center assistant 102 may cause the representative coach 112 to generate output that suggests products or services to callers 106, that presents recommendations to callers 106, and/or otherwise proactively identifies information that may be conveyed to callers 106. As an example, a caller 106 may use certain words or phrases during a contact that suggests, to the task manager 116, that the caller 106 may be interested in a certain product or service. The representative coach 112 may accordingly generate output regarding the product or service identified by the task manager 116.

For instance, a caller 106 may off-handedly mention that they plan to retire in a few months while talking to a representative 104 about a different topic. The caller's mention of an upcoming retirement may indicate that the customer may be interested in a particular type of insurance policy designed for retirees. The task manager 116 may identify that the particular type of insurance policy may be of interest to the caller 106, and the representative coach 112 may accordingly dynamically generate output that prompts the representative 104 to mention that type of insurance policy to the caller 106, explain the type of insurance policy to the caller 106, inquire more about the caller's potential interest in the type of insurance policy, suggest that the caller 106 be transferred to another representative 104 that may have more experience with the type of insurance policy, and/or that expresses any other information associated with the type of insurance policy.

In this example, the caller 106 and/or the representative 104 may not have been aware of the type of insurance policy designed for retirees and/or may not have experience with that type of insurance policy. However, elements of the contact center assistant 102 may steer the conversation between the caller 106 and/or the representative 104 towards that type of insurance policy, based upon a determination that the caller 106 may be likely to have interest in the that type of insurance policy and/or may benefit from that type of insurance policy.

In some examples, the task manager 116 may also, or alternately, automatically complete tasks in association with contacts. As an example, if a caller 106 provides information during a contact with a representative 104, the task manager 116 may automatically propagate the caller-provided information into forms, databases, and/or other destinations without receiving input from the representative 104. For instance, if the caller 106 is communicating with a representative 104 about an insurance policy, information monitored by the contact analyzer 114 may indicate that the caller 106 wants to update beneficiary information associated with the insurance policy. The task manager 116 may identify and use information provided by the caller 106 during the contact to automatically update the beneficiary associated with the insurance policy within insurance policy data and/or other caller data 128. The beneficiary information may thus be updated automatically without manual action by the representative 104.

Automatic performance of tasks by the task manager 116 during contacts may allow the contacts to conclude more quickly, relative to representatives 104 taking time and effort to manually update beneficiary information and/or to perform other tasks manually during the contacts. Accordingly, the task manager 116 may cause the contact center to address callers' issues more quickly and decrease average durations associated with contacts, thereby increasing the number of contacts that may be handled during a day or other time period by the contact center and increasing efficiency of the contact center.

Moreover, automatic performance of tasks by the task manager 116 in association with contacts may decrease the chances of human error. For example, representatives 104 may update forms or databases during contacts with callers 106, but be distracted while communicating with the callers 106 and mistakenly introduce typographical errors and/or forget to correspondingly update other related forms or databases. However, the task manager 116 may automatically update forms or databases substantially immediately and/or correctly, and/or update multiple forms or databases substantially simultaneously, based upon information provided by a caller 106 during a contact.

In some examples, the representative coach 112 may generate output based upon recommendations or suggestions determined by the contact router 120. The contact router 120 may operate during contacts between representatives 104 and callers 106 to determine when and/or if a caller 106 should be transferred to a different representative 104. If the contact router 120 determines that a particular caller 106 should be transferred to a different representative 104, the contact router 120 may prompt the representative coach 112 to generate corresponding output that suggests the transfer to the current representative 104 and/or that explains the suggested transfer to the caller 106.

As an example, a caller 106 may initiate a contact with a first representative 104 in a first department to inquire about a customer account issue. However, the task manager 116 may determine that a recall notice associated with a product owned by the caller 106 has not yet been explained to the caller 106, and could be explained to the caller 106 by a second representative 104 in a maintenance department. The contact router 120 may determine that the first representative 104 should transfer the caller 106 to the second representative 104, or should suggest such a transfer to the caller 106, for instance after the first representative 104 has addressed the customer account issue with the caller 106. The representative coach 112 may accordingly generate output that suggests or explains the transfer, such as “Thank you. I believe we've resolved that account issue for you. While we have you, I see that our maintenance department wanted to talk to you about a recall notice. Do you mind if I transfer you to my colleague in the maintenance department?”

The contact router 120 may also route contacts to particular representatives 104 based upon caller profiles, representative profiles, and/or other information. As an example, if language profile information associated with a caller 106 indicates that the caller 106 speaks Spanish, the contact router 120 may automatically route and/or transfer the caller 106 to a representative 104 that also speaks Spanish. Accordingly, the caller 106 may be directed to a Spanish-speaking representative automatically, without the caller 106 pressing a particular button or providing other input during the contact to indicate that the caller speaks Spanish. Similarly, if profile information associated with a caller 106 indicates that the caller prefers short and straightforward conversations, the contact router 120 may automatically route and/or transfer the caller 106 to a representative 104 that has previously demonstrated an ability to interact with callers quickly and efficiently, instead of another representative 104 that may have a tendency to provide more longwinded answers to callers 106 or be more likely to engage in small talk with callers 106.

The contact router 120 may also route contacts to particular representatives 104 based upon issues or tasks that the task manager 116 and/or other elements of the contact center assistant 102 determines that callers 106 are, or are most likely to be, interested in. As an example, an initial phase of a contact may include an automated system asking a caller 106 why the caller 106 is contacting the contact center. If the caller 106 indicates that the contact is related to a particular issue, the contact router 120 may route the caller 106 to a representative 104 who has experience with that particular issue. As another example, the task manager 116 and/or other elements of the contact center assistant 102 may predict which issues callers 106 are most likely to be interested in, and route contacts to corresponding representatives 104.

For instance, if the contact center is associated with an insurance company and a natural disaster impacts a particular geographic area, the task manager 116 and/or other elements of the contact center assistant 102 may predict that policyholders located in that particular geographic area will most likely be contacting the contact center regarding impacts associated with the natural disaster. The contact center may set up a team of representatives 104 to handle impacts associated with the natural disaster. Accordingly, if caller data 128 indicates that a caller 106 who has initiated a new incoming contact is a policyholder located in the geographic area impacted by the natural disaster, the contact router 120 may automatically route the caller 106 to a representative 104 who has been tasked to assist with issues related to the natural disaster.

Similarly, caller data 128 may indicate that a set of callers 106 has set up automatic payments via a particular bank. If that particular bank fails, those callers 106 may be likely to need to update their automatic payment instructions. The contact router 120 may use the caller data 128 to identify when a caller 106 that had been associated with the failed bank contacts the contact center, predict that the caller 106 is likely calling to update automatic payment instructions, and route the caller 106 to a representative 104 who is able to assist the caller 106 with updating of automatic payment instructions. If the caller 106 did not call to update the automatic payment instructions, the task manager 116 may suggest that the caller's automatic payment instructions be updated, and the representative coach 112 may generate corresponding output that the representative 104 may use to suggest that action to the caller 106. As described above, the task manager 116 may also, in some examples, automatically perform a task during a contact, such as updating automatic payment instructions.

In some examples, the task manager 116, the contact router 120, and/or other elements of the contact center assistant 102 may also proactively suggest or recommend that representatives 104 contact particular callers 106. For example, in a situation in which a bank fails as described above, elements of the contact center assistant 102 may use caller data 128 to identify particular customers who have accounts with the failed bank, and cause representatives 104 to proactively reach out to those customers. Accordingly, any issues or problems that might otherwise have arisen due to the bank failure may be proactively addressed and/or avoided by reaching out to the customers.

Although the representative coach 112 may generate output and present such output to representatives 104 as discussed above, in some examples the representative coach 112 and/or other elements of the contact center assistant 102 may also, or alternately, interact with callers and/or other entities directly. For example, when a caller 106 calls in to the contact center, the representative coach 112 may serve as a chat bot or voice bot that communicates with the caller 106 directly.

The representative coach 112 may, instance, engage in an initial conversation with the caller 106 to ask why the caller is calling and/or to otherwise obtain information about the caller's reason for the call. Obtaining such information may allow the contact router 120 to determine which representative 104 the call should be routed to within the contact center. Similarly, the representative coach 112 may engage in a natural language conversation with the caller 106 to obtain information that identifies the caller 106, provides the caller 106 with information regarding current or predicted hold times and/or other information, and/or otherwise interact with the caller 106 directly.

Overall, the contact center assistant 102 may assist representatives 104 of a call center in association with calls or other types of contacts with callers 106. The contact center assistant 102 may provide the representatives 104, via a UI, with dynamically-generated scripts of natural language questions and/or statements that the representatives 104 may read to callers 106 during contacts. The contact center assistant 102 may also provide the representatives 104 with dynamically-generated output that conveys relevant information to the representatives 104 during contacts, and/or that otherwise assist the representatives 104 during the contacts. For instance, such information may be information that the representative 104 would otherwise not be able to access or identify in real-time during contacts, and/or may be associated with tasks that would not otherwise be performed during the contacts.

The contact center assistant 102 may accordingly increase percentages of contacts that result in first-contact resolutions. For instance, instead of a caller 106 raising an issue during a first contact that is not resolved during the first contact, a representative 104 researching the issue after the first contact, and the representative 104 then contacting the caller 106 again via a second contact to continue addressing the issue, the contact center assistant 102 may allow information relevant to the issue to be quickly and automatically surfaced to the representative during the first contact such that a second contact may be avoided. Similarly, the contact center assistant 102 may surface information about other issues that may or may not be related to a current issue during a current contact, such that subsequent contacts that may otherwise have occurred to address the other issues at later points in time may be avoided by proactively addressing the other issues during the current contact. By avoiding such subsequent contacts, computing resource usage, time, effort, and/or other resources that would have been associated with the subsequent contacts may also be avoided.

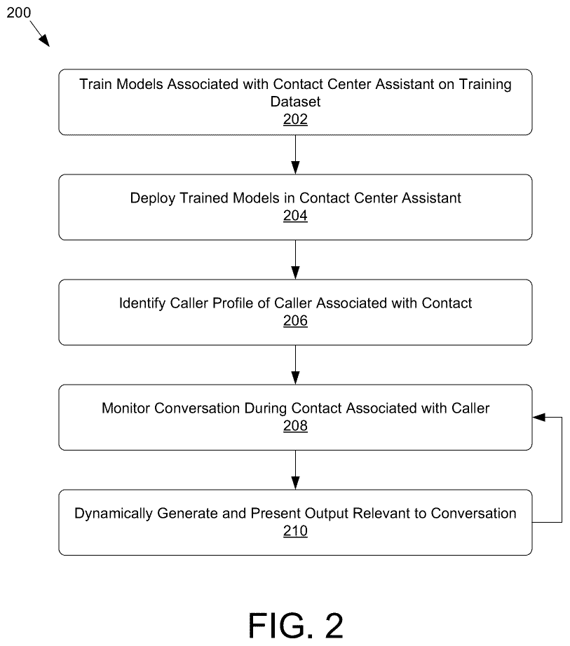

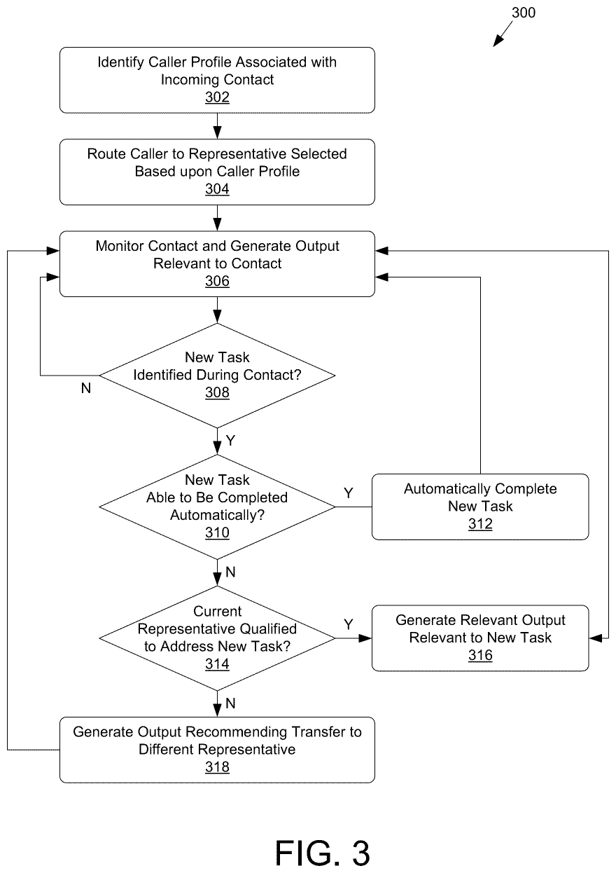

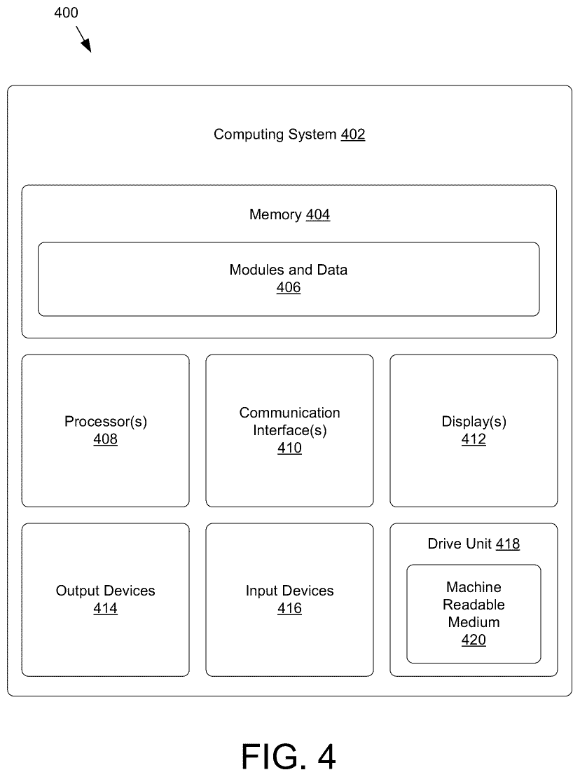

Flowcharts associated with operations associated with elements of the contact center assistant 102 and/or other elements described herein are discussed further below with respect to FIGS. 2 and 3. An exemplary system architecture that may be used to execute the contact center assistant 102 and/or other elements described herein is discussed further below with respect to FIG. 4.

### Exemplary Method for Generating Output During Contacts

FIG. 2 shows a flowchart illustrating an exemplary computer-implemented method 200 for dynamically generating output during contacts via the contact center assistant 102. The method 200 shown in FIG. 2 may be performed by one or more computing systems, such as a computing system that executes the model training system 122 and/or a computing system that executes the contact center assistant 102. An exemplary system architecture for such a computing system is described below with respect to FIG. 4.

At block 202, the model training system 122 may train the representative coach 112 and/or other elements of the contact center assistant 102 on a training dataset. The training dataset may be based upon one or more types of information that may be provided and/or maintained by one or more data sources 124.

For example, the training dataset may be based upon contact data 126 associated with a historical set of contacts, including transcripts and/or recordings of the contacts, QA data and/or feedback indicating whether individual contacts were considered to be desirable or undesirable instances of interactions with callers 106, and/or other information. Accordingly, the model training system 122 may train the representative coach 112 to, in response to one or more types of input, dynamically generate natural language output based at least in part upon contact data 126 associated with a set of contacts that have been determined to be associated with historical instances of desirable interactions with callers 106.

The training dataset may also, or alternately be based upon caller data 128 that may indicate language preferences of callers 106, customer profiles indicating purchase histories and/or products or services associated with callers 106, and/or other information regarding callers 106. Accordingly, the model training system 122 may train the representative coach 112 to, in response to one or more types of input, dynamically generate natural language output that expresses information based upon language preferences of corresponding callers 106.

As described herein, the representative coach 112 may be based upon a GPT model, such as a large language model, that is trained based the training dataset using supervised learning, reinforcement learning, and/or other machine learning techniques. Accordingly, the model training system 122 may train the representative coach 112 at block 202 to generate questions and statements that convey information in natural language and are relevant to current and/or previous information conveyed during a particular contact with a caller 106, and/or that are relevant to other topics or tasks that may be addressed during the contact.

The representative coach 112 may be trained to dynamically generate such output based upon information that was in the training dataset at the time the representative coach 112 was trained, and/or based upon other information that may be accessed by the representative coach 112 after training of the representative coach 112, such as information about a current contact stored in contact data 126 and/or information about a particular caller stored in caller data 128. In examples in which other elements of the contact center assistant 102, such as the contact analyzer 114, the task manager 116, the profile manager 118, the contact router 120, and/or other elements described herein are based upon different or separate machine learning models, the model training system 122 may also train such machine learning models at block 202 via supervised and/or unsupervised machine learning techniques.

At block 204, trained models associated with the representative coach 112 and/or other elements of the contact center assistant 102 may be deployed in the contact center assistant 102. As discussed above, the contact center assistant 102 may execute at, and/or be accessible via, a representative device 110, such that a representative 104 associated with the representative device 110 may read or otherwise perceive output generated by the contact center assistant 102 during contacts with callers 106. Accordingly, output generated by the contact center assistant 102 may assist the representative 104 in one or more ways during contacts with callers 106.

At block 206, the contact center assistant 102 may identify a caller profile of a caller 106 associated with a particular contact. For example, when an incoming telephone call arrives from a caller 106, the profile manager 118 or other element of the contact center assistant 102 may use a telephone number of the caller 106, information provided by the caller 106, or any other data to identify a profile associated with that caller that is stored in the caller data 128. As discussed above, such a profile of the caller 106 may indicate language preferences of the caller 106, such as a language, dialect, or tone that the caller 106 prefers. The caller profile may also indicate products or services associated with the caller 106. For instance, if the caller 106 is a policyholder of an insurance policy, the caller profile may indicate information about the insurance policy, such as a policy number, information about what the insurance policy covers, billing information associated with the insurance policy, and/or any other information.

At block 208, the contact center assistant 102 may monitor a conversation between the representative 104 and the caller 106 during the particular contact. For example, the contact analyzer 114 may record and/or transcribe the conversation, analyze sentiment expressed by the representative 104 and/or the caller 106 during the conversation, and/or perform other monitoring and/or analysis of the conversation.

At block 210, the contact center assistant 102 may dynamically generate and present output that is relevant to the conversation. The output may be presented via a UI of the contact center assistant 102 that is displayed via the representative device 110. For example, the representative coach 112 may use a transcript of the conversation generated by the contact analyzer 114 at block 208 to identify questions posed during the conversation, and dynamically generate natural language output that expresses answers to the questions. The representative 104 may read the natural language output to the caller 106, or otherwise use the natural language output during the contact.

The representative coach 112 may generate such output based upon a sentiment analysis of the conversation, for instance to generate output expressed in language and/or a tone that matches or is responsive to a sentiment expressed by the caller 106 during the conversation. The representative coach 112 may also, or alternately, use information associated with the caller profile identified at block 206 to generate output at block 210. As an example, the representative coach 112 may generate natural language output expressed in accordance with language preferences of the caller 106 identified in the caller profile. As another example, the representative coach 112 may generate natural language output that expresses information specific to the caller's insurance policy, or other products or services associated with the caller 106, based upon corresponding information identified in the caller profile.

Similarly, the task manager 116 may use a transcript of the conversation, caller data 128 associated with the caller 106, and/or other information to identify additional tasks that may be addressed during the contact. Accordingly, the representative coach 112 may generate corresponding natural language output related to the identified tasks, such as questions or comments related to the identified tasks that the representative 104 may use during the contact. Examples of identifying tasks and generating corresponding tasks are discussed further below with respect to FIG. 3.

After generating and presenting output during the contact at block 210, the contact center assistant 102 may continue monitoring the contact at block 208 and generating relevant output at block 210. Accordingly, the contact center assistant 102 may continue monitoring the conversation, and dynamically generating and presenting output relevant to the conversation, until the contact ends.

The contact center assistant 102 may also perform other types of operations during a contact. Examples of such operations are discussed further below with respect to FIG. 3.

### Exemplary Computer-Based Method for Managing Contacts

FIG. 3 shows a flowchart illustrating an exemplary computer-implemented method 300 for managing a contact via the contact center assistant 102. The method 300 shown in FIG. 3 may be performed by one or more computing systems, such as a computing system that executes the contact center assistant 102. An exemplary system architecture for such a computing system is described below with respect to FIG. 4.

At block 302, the contact center assistant 102 may identify a caller profile of a caller 106 associated with an incoming contact. For example, as discussed above with respect to block 206 of FIG. 2, when an incoming telephone call arrives from a caller 106, the profile manager 118 or other element of the contact center assistant 102 may use a telephone number of the caller 106, information provided by the caller 106, or any other data to identify a profile associated with that caller that is stored in the caller data 128. As discussed above, such a profile of the caller 106 may indicate language preferences of the caller 106, such as a language, dialect, or tone that the caller 106 prefers. The caller profile may also indicate products or services associated with the caller 106. For instance, if the caller 106 is a policyholder of an insurance policy, the caller profile may indicate information about the insurance policy, such as a policy number, information about what the insurance policy covers, billing information associated with the insurance policy, and/or any other information.

At block 304, the contact router 120 of the contact center assistant 102 may route the caller 106 to a particular representative 104 selected based at least in part upon the caller profile identified at block 302. As an example, if the caller profile indicates that the caller 106 speaks a particular language, the contact router 120 may automatically route the incoming call to a representative 104 who speaks that particular language. As another example, if the caller profile indicates that the caller 106 generally prefers lighthearted and/or humorous conversations, the contact router 120 may automatically route the incoming call to a representative 104 who, based upon a profile of the representative 104, has demonstrated a tendency to interact with callers 106 in a lighthearted and/or humorous way. As yet another example, if the caller profile indicates that the caller is located in a particular area that has been affected by a natural disaster, and may thus be likely to be calling in about impacts of the natural disaster, the contact router 120 may automatically route the incoming call to a representative 104 who has been tasked to assist people who have been impacted by the natural disaster.

At block 306, the contact center assistant 102 may monitor the contact and generate output relevant to the contact. For example, as discussed above with respect to block 208 and block 210 of FIG. 2, the contact analyzer 114 may monitor a conversation that occurs between the representative 104 and the caller 106 during the contact, such that the representative coach 112 may dynamically generate and present output relevant to the conversation during the contact.

As discussed above, the task manager 116 may monitor the conversation during the contact, and/or evaluate caller data 128 and/or other information associated with the caller 106 during the contact, to potentially identify any tasks or issues that could be addressed during the contact in addition to the issue that was the original reason for the contact. For example, if the caller 106 initiated the contact to address a first issue, the task manager 116 may determine that a second issue could also be addressed during the contact. The second issue may be related or unrelated to the first issue. For example, the second issue may relate to a different product or service than the first issue, or may be associated with an account issue that is unrelated to the first issue. Accordingly, in some examples, the second issue may be an issue that the representative 104 and/or the caller 106 might not otherwise have discussed during the contact.

Accordingly, at block 308, the contact center assistant 102 may determine if the task manager 116 has identified a new task during the contact. If the task manager 116 has not identified a new task (Block 308—No), the contact center assistant 102 may continue monitoring the contact and generating relevant output at block 306. However, if the task manager 116 has not identified a new task (Block 308—No), the contact center assistant 102 may determine at block 310 whether the new task is a task that the task manager 116 may perform automatically.

If the new task identified at block 308 may be performed automatically (Block 310—Yes), the task manager 116 may perform the task automatically at block 312, in some examples without further input or instructions from the representative 104. As an example, if the new task involves filling in forms or database fields with information that has already been provided by the caller 106, the task manager 116 may automatically fill in such forms or database fields with the caller-provided information at block 312. Accordingly, the representative 104 may continue focusing on other tasks during the contact, such as tasks related to the original reason for the contact. The contact center assistant 102 may also continue to monitor the contact and generate relevant output at block 306.

If the new task identified at block 308 may not be performed automatically (Block 312—No), the contact center assistant 102 may determine whether the current representative 104 is qualified to address the new task. For example, if the current representative 104 is associated with a particular department, the new task may be a type of task that the particular department also handles, or may be a type of task that is normally handled by representatives 104 associated with a different department. As another example, the current representative 104 may have a particular skill set, a particular experience level, and/or particular certifications that qualify the current representative 104 to handle a current task for the caller 106, but the new task may be a type of task that is to be handled by a representative 104 with a different skill set, experience level, and/or certifications.

Accordingly, if the current representative 104 is qualified to address the new task (Block 314—Yes), at block 316 the contact center assistant 102 may generate output during the contact that is relevant to the new task. For instance, the representative coach 112 may generate a suggested question related to the new task, a recommended statement that may transition the conversation with the caller 106 to the new task, and/or other types of output that may be relevant to the new task. Accordingly, the current representative may read the output generated at block 316 to the caller 106 to introduce and/or inquire about the new task during the contact. The contact center assistant 102 may also continue to monitor the contact and generate relevant output at block 306.

If the current representative 104 is not qualified to address the new task (Block 314—No), at block 318 the contact center assistant 102 may generate output recommending that the caller 106 be transferred from the current representative 104 to a different representative 104. The different representative 104 may be a representative 104 who is recommended, by the contact router 120, to handle the new task, for instance based upon a type of the new task, the caller profile, and/or other information. The output generated at block 318 may introduce the new task, suggest that the caller 106 be transferred to the new representative 104 in order to address the new task, may introduce the new representative 104 to the caller 106, and/or may otherwise express information associated with the recommended transfer.

If the caller 106 agrees to communicate with the new representative 104 about the new task, the contact may be transferred to the new representative 104, and the contact center assistant 102 may also monitor the transferred contact and generate relevant output at block 306. If the caller 106 does not agree to be transferred to the new representative 104, or the current representative 104 wants to continue speaking with the caller 106 about another issue before the recommended transfer occurs, the contact center assistant 102 may continue to monitor the contact and generate relevant output at block 306.

### Exemplary Computer System Architecture

FIG. 4 shows an exemplary system architecture 400 for a computing system 402 that may execute one or more elements associated with the contact center assistant 102, the model training system 122, and/or other elements described herein. In some examples, the computing system 402 may be, or include, the representative device 110. In other examples, the computing system 402 may also, or alternatively, include a server and/or elements of a cloud computing system that is separate and/or remote from the representative device 110. The computing system 402 may include one or more computers, servers, or other types of computing devices. Individual computing devices of the computing system 402 may have the system architecture 400 shown in FIG. 4, or a similar system architecture. The user device 108 may also have a system architecture similar to the architecture shown in FIG. 4.

In some examples, elements of the contact center assistant 102, the model training system 122, and/or other elements described herein may be distributed among, and/or be executed by, multiple computing systems or devices similar to the computing system 402 shown in FIG. 4. As an example, frontend elements of the contact center assistant 102 may be executed by, and/or be accessible via, the representative device 110, while backend elements of the contact center assistant 102 may be executed by one or more remote servers and/or elements of a cloud computing environment. As another example, the model training system 122 may be executed via one or more computing systems that are different from one or more computing systems that execute the contact center assistant 102.

The computing system 402 may include memory 404. In various examples, the memory 404 may include system memory, which may be volatile (such as RAM), non-volatile (such as ROM, flash memory, etc.) or some combination of the two. The memory 404 may further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which may be used to store desired information and which may be accessed by the computing system 402. Any such non-transitory computer-readable media may be part of the computing system 402.

The memory 404 may store modules and data 406, including software or firmware elements, such as data and/or computer-readable instructions that are executable by one or more processors 408. As an example, the memory 404 may store computer-executable instructions and data associated with one or more elements of the contact center assistant 102, such as the representative coach 112, the contact analyzer 114, the task manager 116, the profile manager 118, the contact router 120, and/or other elements. As another example, the memory 404 may store computer-executable instructions and data associated with the model training system 122.

The modules and data 406 stored in the memory 4504 may also include any other modules and/or data that may be utilized by the computing system 402 to perform or enable performing any action taken by the computing system 402. Such modules and data 406 may include a platform, operating system, and applications, and data utilized by the platform, operating system, and applications.

The computing system 402 may also have processor(s) 408, communication interfaces 410, a display 412, output devices 414, input devices 416, and/or a drive unit 418 including a machine readable medium 420.

In various examples, the processor(s) 408 may be a central processing unit (CPU), a graphics processing unit (GPU), both a CPU and a GPU, or any other type of processing unit. Each of the one or more processor(s) 408 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 408 may also be responsible for executing computer applications stored in the memory 404, which may be associated with types of volatile (RAM) and/or nonvolatile (ROM) memory.

The communication interfaces 410 may include transceivers, modems, network interfaces, antennas, and/or other components that may transmit and/or receive data over networks or other connections. The communication interfaces 410 may be used to exchange data between elements described herein. For instance, in some examples, the communication interfaces 410 may receive user input and/or other data associated with a contact between a representative 104 and a caller 106. The communication interfaces 410 may also transmit or receive data via cellular networks, wireless networks, and/or other networks. For instance, the communication interfaces 410 may be used to access one or more types of information from one or more data sources 124.

The display 412 may be a liquid crystal display, or any other type of display used in computing devices. In some examples, the display 412 may be a screen or other display of the representative device 110. The output devices 414 may include any sort of output devices known in the art, such as the display 412, speakers, chat bot, voice bot, VR headsets, AR glasses, smart glasses, mobile devices, smart watches, wearables, other devices discussed elsewhere herein, a vibrating mechanism, and/or a tactile feedback mechanism. Output devices 414 may also include ports for one or more peripheral devices, such as peripheral speakers and/or a peripheral display. In some examples, output of the representative coach 112 and/or other elements of the contact center assistant 102 may be presented via the display 412 and/or the output devices 414.

The input devices 416 may include any sort of input devices known in the art. For example, input devices 416 may include a microphone, a keyboard/keypad, voice bot, chatbot, VR headset, smart glasses, AR glasses, wearables, mobile devices, other devices discussed elsewhere herein, and/or a touch-sensitive display, such as a touch-sensitive display screen. A keyboard/keypad may be a push button numeric dialing pad, a multi-key keyboard, or one or more other types of keys or buttons, and may also include a joystick-like controller, designated navigation buttons, or any other type of input mechanism.

The machine readable medium 420 may store one or more sets of instructions, such as software or firmware, that embodies any one or more of the methodologies or functions described herein. The instructions may also reside, completely or at least partially, within the memory 404, processor(s) 408, and/or communication interface(s) 410 during execution thereof by the computing system 402. The memory 404 and the processor(s) 408 also may constitute machine readable media 420.

Although the subject matter has been described in language specific to structural features and/or methodological acts, it is to be understood that the subject matter is not necessarily limited to the specific features or acts described above. Rather, the specific features and acts described above are disclosed as example embodiments.

### EXEMPLARY EMBODIMENTS

In one aspect, a computer-implemented method may assist a representative associated with a contact center during a contact with a caller. The computer-implemented method may be implemented via one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another and/or any of which may be configured to operate as an input and/or output device. For instance, in one embodiments, the method may include (1) providing, by a computing system including one or more processors, a contact center assistant including a representative coach, wherein the representative coach is trained, based upon a training dataset, to assist a representative associated with a contact center; (2) monitoring, by the computing system, and via the contact center assistant, a contact between a caller and the representative associated with a contact center; (3) dynamically generating, by the computing system, and via the representative coach based at least in part upon monitoring the contact, natural language output associated with the contact; and/or (4) presenting, by the computing system, the natural language output to the representative via a user interface of the contact center assistant. The method may include additional, less, or alternate functionality, including that discussed elsewhere herein.

For instance, the representative coach may include a generative pre-trained transformer (GPT) model trained on the training dataset. The training dataset may include (i) contact data including information associated with a set of historical contacts; and/or (ii) caller data including profiles of callers. The contact data may, for instance, include feedback data distinguishing desirable historical contacts from undesirable historical contacts. The natural language output may express (i) recommended answer to a question posed by the caller during the contact; and/or (ii) a suggested question to pose to the caller during the contact.

In some aspects, the method may include identifying, by the computing system, a caller profile of the caller. The caller profile may indicate language preferences of the caller, and the representative coach may generate the natural language output in accordance with the language preferences of the caller. The caller profile may also, or alternately, indicate one or more products or services associated with the caller, and the natural language output generated by the representative coach may express at least one of a question or a statement that corresponds with the one or more products or services associated with the caller. The computing system may also, or alternately, (i) select the representative based upon the caller profile; and/or (ii) route the contact to the representative.

In some aspects, the contact may be initiated to address a first task associated with the caller. The method may include identifying, by the computing system, and via the contact center assistant during the contact, a second task associated with the caller. The method may further include automatically performing, by the computing system, and via the contact center assistant, the second task during the contact without user input from the representative. In some aspects, the natural language output may express at least one of a question or a statement associated with the second task. In certain aspects, the natural language output may be associated with a recommended transfer of the contact to a different representative associated with the second task.

In another aspect, a computing system may be provided. The computing system may include one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another and/or any of which may be configured as an input and/or output device. For instance, in one embodiment, the computer system may include one or more processors, and memory storing computer-executable instructions associated with a contact center assistant. The computer-executable instructions, when executed by the one or more processors, may cause the one or more processors to: (1) monitor, via the contact center assistant, a contact between a caller and a representative associated with a contact center; (2) dynamically generate, by a representative coach of the contact center assistant, natural language output associated with the contact, wherein the representative coach includes a generative pre-trained transformer (GPT) model that is trained on a training dataset; and/or (3) present the natural language output to the representative via a user interface of the contact center assistant. The computing system may provide additional, less, or alternate functionality, including that discussed elsewhere herein.

In another aspect, one or more non-transitory computer-readable media storing computer-executable instructions associated with a contact center assistant may be provided. The computer-executable instructions, when executed by one or more processors of a computing system, may cause the one or more processors to: (1) monitor, via the contact center assistant, a contact between a caller and a representative associated with a contact center; (2) dynamically generate, by a representative coach of the contact center assistant, natural language output associated with the contact, wherein the representative coach includes a generative pre-trained transformer (GPT) model that is trained on a training dataset; and/or (3) present the natural language output to the representative via a user interface of the contact center assistant. The computer-executable instructions may provide additional, less, or alternate functionality, including that discussed elsewhere herein.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

1. A computer-implemented method for providing assistance to a representative associated with a contact center, the method comprising:
providing, by a computing system comprising one or more processors, a contact center assistant comprising a representative coach, wherein the representative coach is trained, based upon a training dataset, to assist the representative associated with the contact center;
monitoring, by the computing system, and via the contact center assistant, a contact between a caller and the representative associated with the contact center;
dynamically generating, by the computing system, and via the representative coach based at least in part upon monitoring the contact, natural language output associated with the contact; and
presenting, by the computing system, the natural language output to the representative via a user interface of the contact center assistant.

2. The computer-implemented method of claim 1, wherein the representative coach comprises a generative pre-trained transformer (GPT) model trained on the training dataset.

3. The computer-implemented method of claim 1, wherein the training dataset comprises at least one of:
contact data comprising information associated with a set of historical contacts, or
caller data comprising profiles of callers.

4. The computer-implemented method of claim 3, wherein the contact data comprises feedback data distinguishing desirable historical contacts from undesirable historical contacts.

5. The computer-implemented method of claim 1, wherein the natural language output expresses at least one of:
a recommended answer to a question posed by the caller during the contact, or
a suggested question to pose to the caller during the contact.

6. The computer-implemented method of claim 1, further comprising:
identifying, by the computing system, a caller profile of the caller that indicates language preferences of the caller,
wherein the representative coach generates the natural language output in accordance with the language preferences of the caller.

7. The computer-implemented method of claim 1, further comprising:
identifying, by the computing system, a caller profile of the caller that indicates one or more products or services associated with the caller,
wherein the natural language output generated by the representative coach expresses at least one of a question or a statement that corresponds with the one or more products or services associated with the caller.

8. The computer-implemented method of claim 1, further comprising:
identifying, by the computing system, a caller profile of the caller;
selecting, by the computing system, the representative based upon the caller profile; and
routing, by the computing system, the contact to the representative.

9. The computer-implemented method of claim 1, wherein:
the contact is initiated to address a first task associated with the caller, and
the method further comprises identifying, by the computing system, and via the contact center assistant during the contact, a second task associated with the caller.

10. The computer-implemented method of claim 9, further comprising automatically performing, by the computing system, and via the contact center assistant, the second task during the contact without user input from the representative.

11. The computer-implemented method of claim 9, wherein the natural language output expresses at least one of a question or a statement associated with the second task.

12. The computer-implemented method of claim 9, wherein the natural language output is associated with a recommended transfer of the contact to a different representative associated with the second task.

13. A computing system configured to provide assistance to a representative associated with a contact center, the computing system comprising:
one or more processors, and
memory storing computer-executable instructions associated with a contact center assistant that, when executed by the one or more processors, cause the one or more processors to:
monitor, via the contact center assistant, a contact between a caller and the representative associated with the contact center;
dynamically generate, by a representative coach of the contact center assistant, natural language output associated with the contact, wherein the representative coach comprises a generative pre-trained transformer (GPT) model that is trained on a training dataset; and
present the natural language output to the representative via a user interface of the contact center assistant.

14. The computing system of claim 13, wherein the training dataset comprises contact data, associated with historical contacts, comprising:
transcripts of the historical contacts, and
feedback data distinguishing desirable instances of the historical contacts from undesirable instances of the historical contacts.

15. The computing system of claim 13, wherein the natural language output expresses at least one of:
a recommended answer to a question posed by the caller during the contact,
a suggested question to pose to the caller during the contact,
a suggested transfer to a different representative, or
a suggested task to complete during the contact.

16. The computing system of claim 13, wherein the computer-executable instructions further cause the representative coach to generate the natural language output based upon at least one of:
language preferences of the caller, or
sentiment analysis of the contact.

17. One or more non-transitory computer-readable media storing computer-executable instructions, associated with a contact center assistant configured to provide assistance to a representative associated with a contact center, that, when executed by one or more processors of a computing system, cause the one or more processors to:
monitor, via the contact center assistant, a contact between a caller and the representative associated with the contact center;
dynamically generate, by a representative coach of the contact center assistant, natural language output associated with the contact, wherein the representative coach comprises a generative pre-trained transformer (GPT) model that is trained on a training dataset; and
present the natural language output to the representative via a user interface of the contact center assistant.

18. The one or more non-transitory computer-readable media of claim 17, wherein the natural language output expresses at least one of:
a recommended answer to a question posed by the caller during the contact,
a suggested question to pose to the caller during the contact,
a suggested transfer to a different representative, or
a suggested task to complete during the contact.

19. The one or more non-transitory computer-readable media of claim 17, wherein the computer-executable instructions further cause the representative coach to generate the natural language output based upon at least one of:
language preferences of the caller, or
sentiment analysis of the contact.

20. The one or more non-transitory computer-readable media of claim 17, wherein:
the contact is initiated to address a first task associated with the caller, and the computer-executable instructions further cause the one or more processors to:
identify, during the contact, a second task associated with the caller; and
automatically perform the second task during the contact without user input from the representative.
